(19) United States
(12) Patent Application Publication
(10) Pub. No.: US 2015/0173364 A1
(43) Pub. Date: Jun. 25, 2015

(54) HERBICIDAL COMPOSITIONS CONTAINING FLUMIOXAZIN, AMINOPYRALID AND FLUROXYPYR OR 2,4-D

(71) Applicant: Dow AgroSciences LLC, Indianapolis, IN (US)

(72) Inventors: Neivaldo Tunes Caceres, Sao Jose Do Rio Preto (BR); Felipe Pecinatto Daltro, Palmas (BR); Robert A. Masters, Zionsville, IN (US)

(73) Assignee: DOW AGROSCIENCES LLC, Indianapolis, IN (US)

(21) Appl. No.: 14/566,809

(22) Filed: Dec. 11, 2014

Related U.S. Application Data
(60) Provisional application No. 61/919,056, filed on Dec. 20, 2013.

(51) Int. Cl. A01N 43/84; A01N 37/38; A01N 43/40

(52) U.S. Cl. CPC A01N 43/84; A01N 43/40; A01N 37/38

(57) ABSTRACT

Herbicidal compositions comprising (a) flumioxazin and (b) aminopyralid or salt thereof and (c) either fluroxypyr or ester thereof or 2,4-D or salt thereof are described herein.

### CROSS REFERENCE TO RELATED APPLICATIONS

This application claims the benefit of U.S. Provisional Patent Application Ser. No. 61/919,056, filed Dec. 20, 2013, the disclosure of which is expressly incorporated herein by reference.

### BACKGROUND

The occurrence of undesirable vegetation, e.g., weeds, is a constant problem facing farmers in crops, pastures, and other settings. Weeds compete with crops and negatively impact crop yield. The use of chemical herbicides is an important tool in controlling undesirable vegetation. There remains a need for chemical compositions and weed-control methods that offer a broad spectrum of weed control, selectivity, minimal crop damage, storage stability, ease of handling, higher activity against weeds, and/or a means to address herbicide-tolerance that develops with respect to herbicides currently in use.

### SUMMARY

The present disclosure describes herbicidal compositions including three herbicidal active ingredients wherein the first herbicidal active ingredient is flumioxazin, the second herbicidal active ingredient is aminopyralid or a salt thereof, and the third herbicidal active ingredient is 2,4-D or a salt thereof or fluroxypyr or an ester thereof. When the third active ingredient is 2,4-D, the 2,4-D can be, for example, a 2,4-D choline salt or a 2,4-D triisopropanolammonium salt. When the third active ingredient is fluroxypyr, the fluroxypyr can be, for example, fluroxypyr 1-methylheptyl ester.

Additionally described are methods for controlling undesirable vegetation comprising post-emergently contacting the undesirable vegetation or area adjacent to the vegetation or pre-emergently applying to soil a herbicidally effective amount of three herbicidal active ingredients wherein the first herbicidal active ingredient is flumioxazin, the second herbicidal active ingredient is aminopyralid or a salt thereof, and the third herbicidal active ingredient is 2,4-D or a salt thereof or fluroxypyr or an ester thereof. When the third active ingredient is 2,4-D, the 2,4-D can be, for example, a 2,4-D choline salt or a 2,4-D triisopropanolammonium salt. When the third active ingredient is fluroxypyr, the fluroxypyr can be, for example, fluroxypyr 1-methylheptyl ester.

### DETAILED DESCRIPTION

Provided herein are herbicidal compositions comprising herbicidally effective amounts of three herbicidal active ingredients, wherein the first herbicidal active ingredient is flumioxazin, the second herbicidal active ingredient is aminopyralid or salt thereof, and the third herbicidal active ingredient is either 2,4-D or salt thereof or fluroxypyr or ester thereof.

Additionally provided herein are methods of controlling undesirable vegetation comprising applying herbicidally effective amounts of the three herbicidal active ingredients, wherein the first herbicidal active ingredient is flumioxazin, the second herbicidal active ingredient is aminopyralid and the third herbicidal active ingredient is either 2,4-D or fluroxypyr.

As used herein, flumioxazin is 2-[7-fluoro-3,4-dihydro-3-oxo-4-(2-propyn-1-yl)-2H-1,4-benzoxazin-6-yl]-4,5,6,7-tetrahydro-1H-isoindole-1,3(2H)-dione. Flumioxazin has the following structure:

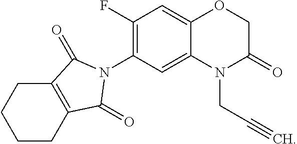 [SMILES: C#CCN1C(=O)COc2cc(F)c(N3C(=O)C4=C(CCCC4)C3=O)cc21]

Exemplary herbicidal uses are provided in Tomlin, C. D. S., Ed. The Pesticide Manual: A World Compendium, 15^{th} ed., BCPC: Alton, 2009 (hereafter “The Pesticide Manual, Fifteenth Edition, 2009”). Exemplary uses of flumioxazin include, but are not limited to, the pre-emergent control of annual broad-leaved weeds and annual grasses in soybean, peanut and orchards.

As used herein, aminopyralid is 4-amino-3,6-dichloro-2-pyridinecarboxylic acid. Aminopyralid has the following structure:

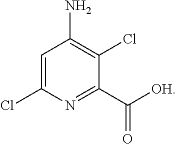 [SMILES: Nc1cc(Cl)nc(C(=O)O)c1Cl]

Exemplary herbicidal uses are described in The Pesticide Manual, Fifteenth Edition, 2009. Exemplary uses of aminopyralid include, but are not limited to, its use as a herbicide for the control of annual and perennial grass and broad-leaved weeds in grassland. Exemplary aminopyralid salts include the potassium salt and the triisopropanolammonium salt.

As used herein, 2,4-D is 2-(2,4-dichlorophenoxyl)acetic acid. 2,4-D has the following structure:

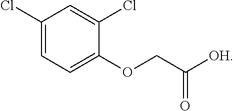 [SMILES: O=C(O)COc1ccc(Cl)cc1Cl]

Exemplary herbicidal uses are described in The Pesticide Manual, Fifteenth Edition, 2009. Exemplary uses of 2,4-D include, but are not limited to, its use as a post-emergence herbicide for the control of annual and perennial broad-leaved weeds in cereals, corn/maize, sorghum, grassland, established turf, grass seed crops, orchards, cranberries, asparagus, sugar cane, rice, forestry and on non-crop land and also for the control of broad-leaved aquatic weeds. In certain embodiments, it can be used as the acid itself or as an agriculturally acceptable salt or ester. Exemplary 2,4-D salts include the choline salt, the dimethylammonium salt, the diethanolammonium salt, the sodium salt, the triisopropanolammonium salt, and the triethanolammonium salt. Exemplary esters include the butoxyethyl ester, the butyl ester, the ethyl ester, the 2-ethylhexyl ester, the isobutyl ester, the mixed octyl ester, and the isopropyl ester.

As used herein, fluroxypyr is 2-[(4-amino-3,5-dichloro-6-fluoro-2-pyridinyl)oxy]acetic acid. Fluroxypyr has the following structure:

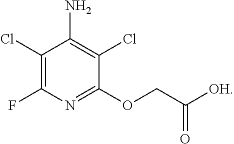 [SMILES: Nc1c(Cl)c(F)nc(OCC(=O)O)c1Cl]

Exemplary herbicidal uses are described in The Pesticide Manual, Fifteenth Edition, 2009. Exemplary uses of fluroxypyr include, but are not limited to, its use as a herbicide for the post-emergence control of broad-leaved weeds in all small grain crops, pastures, grassland, apple orchards, rubber, oil palm, and conifer. Exemplary fluroxypyr esters include the 2-butoxy-1-methylethyl ester and the 1-methylheptyl ester.

As used herein, a herbicidally effective or vegetation controlling amount is an amount of active ingredient (or combination of ingredients) which causes an adversely modifying effect to the vegetation e.g., causing deviations from natural development, killing, effecting regulation, causing desiccation, causing retardation, or the like.

As used herein, controlling undesirable vegetation means preventing, reducing, killing, or otherwise adversely modifying the development of plants and vegetation. Described herein are methods of controlling undesirable vegetation through the application of certain herbicide combinations or compositions. Methods of application include, but are not limited to, applications to the vegetation or locus thereof, e.g., application to the area adjacent to the vegetation, as well as preemergence, postemergence, foliar (broadcast, directed, banded, spot, mechanical, over-the-top, or rescue), and in-water applications (emerged and submerged vegetation, broadcast, spot, mechanical, water-injected, granular broadcast, granular spot, shaker bottle, or stream spray) via hand, backpack, machine, tractor, or aerial (airplane and helicopter) application methods.

As used herein, plants and vegetation include, but are not limited to, germinant seeds, emerging seedlings, plants emerging from vegetative propagules, immature vegetation, and established vegetation.

In some embodiments, the compositions and methods provided herein are utilized to control weeds in crops, including but not limited to pastures, grasslands, rangelands, fallowland, turf, industrial vegetation mangement (IVM), and rights-of-way.

The compositions and methods described herein can be used to control undesirable vegetation in glyphosate-tolerant-, glufosinate-tolerant-, dicamba-tolerant-, phenoxy auxin-tolerant-, pyridyloxy auxin-tolerant-, aryloxyphenoxypropionate-tolerant-, acetyl CoA carboxylase (ACCase) inhibitor-tolerant-, imidazolinone-tolerant-, acetolactate synthase (ALS) inhibitor-tolerant-, 4-hydroxyphenyl-pyruvate dioxygenase (HPPD) inhibitor-tolerant-, protoporphyrinogen oxidase (PPO) inhibitor-tolerant-, triazine-tolerant- and bromoxynil-tolerant crops (such as, but not limited to, soybean, cotton, canola/oilseed rape, rice, cereals, corn/maize, turf, etc.), for example, in conjunction with glyphosate, glufosinate, dicamba, phenoxy auxins, pyridyloxy auxins, aryloxyphenoxypropionates, ACCase inhibitors, imidazolinones, ALS inhibitors, HPPD inhibitors, PPO inhibitors, triazines, and bromoxynil. The compositions and methods may be used in controlling undesirable vegetation in crops possessing multiple or stacked traits conferring tolerance to multiple chemistries and/or inhibitors of multiple modes-of-action (MOA). In some embodiments, the compositions described herein and other complementary herbicides are applied at the same time, either as a combination formulation, as a tank mix, or as a sequential application.

The compositions and methods provided herein are utilized to control undesirable vegetation. Undesirable vegetation includes, but is not limited to, undesirable vegetation that occurs in pastures, grasslands, rangelands, fallowland, turf, IVM, and rights-of-way.

In some embodiments, the methods provided herein are utilized to control undesirable vegetation found in tree and vine, perennial crops and row crops, including, but not limited to, vineyards, orchards, perennial plantation crops, corn/maize, sorghum, sunflower, canola/oilseed rape and vegetables. In certain embodiments, the undesirable vegetation is Alopecurus myosuroides Huds. (blackgrass, ALOMY), Avena fatua L. (wild oat, AVEFA), Brachiaria platyphylla (Groseb.) Nash (broadleaf signalgrass, BRAPP), Digitaria sanguinalis (L.) Scop. (large crabgrass, DIGSA), Echinochloa crus-galli (L.) P. Beauv. (barnyardgrass, ECHCG), Echinochloa colonum (L.) Link (junglerice, ECHCO), Lolium multiflorum Lam. (Italian ryegrass, LOLMU), Panicum dichotomiflorum Michx. (fall panicum, PANDI), Panicum miliaceum L. (wild-proso millet, PANMI), Setaria faberi Herrm. (giant foxtail, SETFA), Setaria viridis (L.) Beauv. (green foxtail, SETVI), Sorghum halepense (L.) Pers. (Johnsongrass, SORHA), Sorghum bicolor (L.) Moench ssp. Arundinaceum (shattercane, SORVU), Cyperus esculentus L. (yellow nutsedge, CYPES), Cyperus rotundus L. (purple nutsedge, CYPRO), Abutilon theophrasti Medik. (velvetleaf, ABUTH), Amaranthus species (pigweeds and amaranths, AMASS), Ambrosia artemisiifolia L. (common ragweed, AMBEL), Ambrosia psilostachya DC. (western ragweed, AMBPS), Ambrosia trifida L. (giant ragweed, AMBTR), Asclepias syriaca L. (common milkweed, ASCSY), Chenopodium album L. (common lambsquarters, CHEAL), Cirsium arvense (L.) Scop. (Canada thistle, CIRAR), Commelina benghalensis L. (tropical spiderwort, COMBE), Datura stramonium L. (jimsonweed, DATST), Daucus carota L. (wild carrot, DAUCA), Euphorbia heterophylla L. (wild poinsettia, EPHHL), Erigeron bonariensis L. (hairy fleabane, ERIBO), Erigeron canadensis L. (Canadian fleabane, ERICA), Helianthus annuus L. (common sunflower, HELAN), Jacquemontia tamnifolia (L.) Griseb. (smallflower morningglory, IAQTA), Ipomoea hederacea (L.) Jacq. (ivyleaf morningglory, IPOHE), Ipomoea lacunosa L. (white morningglory, IPOLA), Lactuca serriola L./Torn. (prickly lettuce, LACSE), Portulaca oleracea L. (common purslane, POROL), Sida spinosa L. (prickly sida, SIDSP), Sinapis arvensis L. (wild mustard, SINAR), Solanum ptychanthum Dunal (eastern black nightshade, SOLPT), Taraxacum officinale F.H.Wigg (common dandelion, TAROF) or Xanthium strumarium L. (common cocklebur, XANST).

In some embodiments, the methods provided herein are utilized to control undesirable vegetation in range and pasture, IVM and rights-of-way. In certain embodiments, the undesirable vegetation is Ambrosia artemisiifolia L. (common ragweed, AMBEL), Cassia obtusifolia (sickle pod, CASOB), Centaurea maculosa auct. non Lam. (spotted knapweed, CENMA), Cirsium arvense (L.) Scop. (Canada thistle, CIRAR), Convolvulus arvensis L. (field bindweed, CONAR), Euphorbia esula L. (leafy spurge, EPHES), Lactuca serriola L./Torn. (prickly lettuce, LACSE), Melochia parviflora (escoba blanca, MEOPA), Plantago lanceolata L. (buckhom plantain, PLALA), Rumex obtusifolius L. (broadleaf dock, RUMOB), Sida spinosa L. (prickly sida, SIDSP), Sinapis arvensis L. (wild mustard, SINAR), Sonchus arvensis L. (perennial sowthistle, SONAR), Solidago species (goldenrod, SOOSS), Taraxacum officinale G.H. Weber ex Wiggers (dandelion, TAROF), Trifolium repens L. (white clover, TRFRE), or Urtica dioica L. (common nettle, URTDI).

In some embodiments, the compositions and methods provided herein are utilized to control undesirable vegetation consisting of grass, broadleaf and sedge weeds. In certain embodiments, the compositions and methods provided herein are utilized to control members of the genera Borreria or Spermacoce. In certain embodiments, the compositions and methods provided herein are utilized to control Borreria. In some embodiments, the compositions and methods provided herein are utilized to control Borerria verticillata (whitehead broom, BOIVE).

Herbicidal activity is exhibited by the compounds when they are applied directly to the plant, to the area adjacent to the plant (i.e., locus) at any stage of growth or before planting or emergence or after emergence. The components of the mixtures described herein can be applied either separately or as part of a multipart herbicidal system.

In some embodiments, the potassium salt of aminopyralid is utilized. In some embodiments, the triisopropanolammonium salt is utilized.

In some embodiments, the triisopropanolammonium salt of 2,4-D is utilized. In other embodiments, the choline salt of 2,4-D is utilized.

In some embodiments, the 1-methylheptyl ester of fluroxypyr is utilized.

In some embodiments, a mixture of fluroxypyr, i.e., carboxylic acid form, and the 1-methylheptyl ester of fluroxypyr is utilized.

In some embodiments, the second herbicide is the potassium salt of aminopyralid and the third herbicide is the 1-methyl heptyl ester of fluroxypyr.

In some embodiments, the second herbicide is the triisopropanolammonium salt of aminopyralid and the third herbicide is the triisopropanolammonium salt of 2,4-D.

As used herein, the weight ratio of flumioxazin to aminopyralid to fluroxypyr, in cases where salts or esters of aminopyralid and fluroxypyr are used, refers to the ratio of the weight of flumioxazin (in grams active ingredient per hectare (g ai/ha)) to the acid equivalent weight of said salt or ester (in grams acid equivalent per hectare (g ae/ha)).

As used herein, the weight ratio of flumioxazin to aminopyralid to 2,4-D, in cases where salts or esters of aminopyralid and 2,4-D are used, refers to the ratio of the weight of flumioxazin (in grams active ingredient per hectare (g ai/ha)) to the acid equivalent weight of said salt or ester (in grams acid equivalent per hectare (g ae/ha)).

In some embodiments, the compositions comprise and methods utilize flumioxazin, aminopyralid and fluroxypyr. In some embodiments, the weight ratio (calculated from grams of active ingredient (“g ai”) of component (a) and grams of acid equivalent (“g ae”) of components (b) and (c)) of (a) flumioxazin to (b) aminopyralid to (c) fluroxypyr is (a) 25-125 to (b) 80 to (c) 160. In another embodiment, the weight ratio is (a) 25-125 to (b) 40-160 to (c) 80-320. In another embodiment, the weight ratio is (a) 25-125 to (b) 40-100 to (c) 80-320. In another embodiment, the weight ratio is (a) 25-125 to (b) 40-100 to (c) 80-400. In another embodiment, the weight ratio is (a) 25-125 to (b) 70-90 to (c) 120-200. In another embodiment, the weight ratio is (a) 25 to (b) 80 to (c) 160. In another embodiment, the weight ratio is (a) 50 to (b) 80 to (c) 160. In another embodiment, the weight ratio is (a) 75 to (b) 80 to (c) 160. In another embodiment, the weight ratio is (a) 100 to (b) 80 to (c) 160. In another embodiment, the weight ratio is (a) 125 to (b) 80 to (c) 160.

In some embodiments, the compositions comprise and methods utilize flumioxazin, aminopyralid and 2,4-D. In some embodiments, the weight ratio (calculated from grams of active ingredient (“g ai”) of component (a) and grams of acid equivalent (“g ae”) of components (b) and (c)) of (a) flumioxazin to (b) aminopyralid to (c) 2,4-D is (a) 25-125 to (b) 80 to (c) 640. In another embodiment, the weight ratio is (a) 25-125 to (b) 40-160 to (c) 480-1280. In another embodiment, the weight ratio is (a) 25-125 to (b) 40-160 to (c) 480-1440. In another embodiment, the weight ratio is (a) 25-125 to (b) 40-100 to (c) 480-1280. In another embodiment, the weight ratio is (a) 25-125 to (b) 70-90 to (c) 480-800. In another embodiment, the weight ratio is (a) 25 to (b) 80 to (c) 640. In another embodiment, the weight ratio is (a) 50 to (b) 80 to (c) 640. In another embodiment, the weight ratio is (a) 75 to (b) 80 to (c) 640. In another embodiment, the weight ratio is (a) 100 to (b) 80 to (c) 640. In another embodiment, the weight ratio is (a) 125 to (b) 80 to (c) 640.

In certain embodiments, flumioxazin is applied at a rate from about 25 g ai/ha to about 125 g ai/ha, aminopyralid is applied at a rate from about 40 g ae/ha to about 160 g ae/ha, fluroxypyr is applied at a rate from about 80 g ae/ha to about 400 g ae/ha, and 2,4-D is applied at a rate from about 240 g ae/ha to 1440 g ae/ha. In certain embodiments, flumioxazin is applied at a rate from about 25 g ai/ha to about 125 g ai/ha, aminopyralid is applied at a rate from about 70 g ae/ha to about 90 g ae/ha, fluroxypyr is applied at a rate from about 120 g ae/ha to about 200 g ae/ha, and 2,4-D is applied at a rate from about 480 g ae/ha to 800 g ae/ha.

The components of the mixtures described herein can be applied either separately, i.e., sequentially, or as a single composition, i.e., premix. In some embodiments, the components are applied within 1, 2, 4, 6, 8, 10, 12, 14, 16, 18, 20, 22, or 24 hours of each other. In some embodiments, the components are applied within 1, 2, 3, 4, 5, 6, or 7 days of each other. In some embodiments, a single application of each component is utilized. In some embodiments, multiple applications of one or more components is utilized.

The mixtures of the present disclosure can be applied in conjunction with one or more other herbicides to control a wider variety of undesirable vegetation. When used in conjunction with other herbicides, the composition can be formulated with the other herbicide or herbicides, tank-mixed with the other herbicide or herbicides or applied sequentially with the other herbicide or herbicides. Some of the herbicides that can be employed in conjunction with the synergistic composition described herein include, but are not limited to, acid, salt and ester forms of the following herbicides: 4-CPA, 4-CPB, 4-CPP, 2,4-DB, 3,4-DA, 3,4-DB, 2,4-DEB, 2,4-DEP, 3,4-DP, 2,3,6-TBA, 2,4,5-T, 2,4,5-TB, acetochlor, acifluorfen, aclonifen, acrolein, alachlor, allidochlor, alloxydim, allyl alcohol, alorac, ametridione, ametryn, amibuzin, amicarbazone, amidosulfuron, aminocyclopyrachlor, amiprofos-methyl, amitrole, ammonium sulfamate, anilofos, anisuron, asulam, atraton, atrazine, azafenidin, azimsulfuron, aziprotryne, barban, BCPC, beflubutamid, benazolin, bencarbazone, benfluralin, benfuresate, bensulfuron-methyl, bensulide, benthiocarb, bentazon-sodium, benzadox, benzfendizone, benzipram, benzobicyclon, benzofenap, benzofluor, benzoylprop, benzthiazuron, bicyclopyrone, bifenox, bilanafos, bispyribac-sodium, borax, bromacil, bromobonil, bromobutide, bromofenoxim, bromoxynil, brompyrazon, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbetamide, carboxazole, chlorprocarb, carfentrazone-ethyl, CDEA, CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlorimuron, chlornitrofen, chloropon, chlorotoluron, chloroxuron, chloroxynil, chlorpropham, chlorsulfuron, chlorthal, chlorthiamid, cinidon-ethyl, cinmethylin, cinosulfuron, cisanilide, clethodim, cliodinate, clodinafop-propargyl, clofop, clomazone, clomeprop, cloprop, cloproxydim, clopyralid, cloransulam-methyl, CMA, copper sulfate, CPMF, CPPC, credazine, cresol, cumyluron, cyanatryn, cyanazine, cycloate, cyclopyrimorate, cyclosulfamuron, cycloxydim, cycluron, cyhalofop-butyl, cyperquat, cyprazine, cyprazole, cypromid, daimuron, dalapon, dazomet, delachlor, desmedipham, desmetryn, di-allate, dicamba, dichlobenil, dichloralurea, dichlormate, dichlorprop, dichlorprop-P, diclofop, diclosulam, diethamquat, diethatyl, difenopenten, difenoxuron, difenzoquat, diflufenican, diflufenzopyr, dimefuron, dimepiperate, dimethachlor, dimethametryn, dimethenamid, dimethenamid-P, dimexano, dimidazon, dinitramine, dinofenate, dinoprop, dinosam, dinoseb, dinoterb, diphenamid, dipropetryn, diquat, disul, dithiopyr, diuron, DMPA, DNOC, DSMA, EBEP, eglinazine, endothal, epronaz, EPTC, erbon, esprocarb, ethalfluralin, ethbenzamide, ethametsulfuron, ethidimuron, ethiolate, ethobenzamid, etobenzamid, ethofumesate, ethoxyfen, ethoxysulfuron, etinofen, etnipromid, etobenzanid, EXD, fenasulam, fenoprop, fenoxaprop, fenoxaprop-P-ethyl, fenoxaprop-P-ethyl+isoxadifen-ethyl, fenoxasulfone, fenquinotrione, fenteracol, fenthiaprop, fentrazamide, fenuron, ferrous sulfate, flamprop, flamprop-M, flazasulfuron, florasulam, fluazifop, fluazifop-P-butyl, fluazolate, flucarbazone, flucetosulfuron, fluchloralin, flufenacet, flufenican, flufenpyr-ethyl, flumetsulam, flumezin, flumiclorac-pentyl, flumipropyn, fluometuron, fluorodifen, fluoroglycofen, fluoromidine, fluoronitrofen, fluothiuron, flupoxam, flupropacil, flupropanate, flupyrsulfuron, fluridone, flurochloridone, flurtamone, fluthiacet, fomesafen, foramsulfuron, fosamine, furyloxyfen, glufosinate, glufosinate-ammonium, glyphosate, halauxifen, halauxifen-methyl, halosafen, halosulfuron-methyl, haloxydine, haloxyfop-methyl, haloxyfop-P-methyl, hexachloroacetone, hexaflurate, hexazinone, imazamethabenz, imazamox, imazapic, imazapyr, imazaquin, imazethapyr, imazosulfuron, indanofan, indaziflam, iodobonil, iodomethane, iodosulfuron, iofensulfuron, ioxynil, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lactofen, lenacil, linuron, MAA, MAMA, MCPA, MCPA-thioethyl, MCPB, mecoprop, mecoprop-P, medinoterb, mefenacet, mefluidide, mesoprazine, mesosulfuron, mesotrione, metam, metamifop, metamitron, metazachlor, metazosulfuron, metflurazon, methabenzthiazuron, methalpropalin, methazole, methiobencarb, methiozolin, methiuron, methometon, methoprotryne, methyl bromide, methyl isothiocyanate, methyldymron, metobenzuron, metobromuron, metolachlor, metosulam, metoxuron, metribuzin, metsulfuron, molinate, monalide, monisouron, monochloroacetic acid, monolinuron, monuron, morfamquat, MSMA, naproanilide, napropamide, napropamide-M, naptalam, neburon, nicosulfuron, nipyraclofen, nitralin, nitrofen, nitrofluorfen, norflurazon, noruron, OCH, orbencarb, ortho-dichlorobenzene, orthosulfamuron, oryzalin, oxadiargyl, oxadiazon, oxapyrazon, oxasulfuron, oxaziclomefone, oxyfluorfen, paraflufen-ethyl, parafluron, paraquat, pebulate, pelargonic acid, pendimethalin, penoxsulam, pentachlorophenol, pentanochlor, pentoxazone, perfluidone, pethoxamid, phenisopham, phenmedipham, phenmedipham-ethyl, phenobenzuron, phenylmercury acetate, picloram, picolinafen, pinoxaden, piperophos, potassium arsenite, potassium azide, potassium cyanate, pretilachlor, primisulfuron-methyl, procyazine, prodiamine, profluazol, profluralin, profoxydim, proglinazine, prohexadione-calcium, prometon, prometryn, propachlor, propanil, propaquizafop, propazine, propham, propisochlor, propoxycarbazone, propyrisulfuron, propyzamide, prosulfalin, prosulfocarb, prosulfuron, proxan, prynachlor, pydanon, pyraclonil, pyraflufen, pyrasulfotole, pyrazogyl, pyrazolynate, pyrazosulfuron-ethyl, pyrazoxyfen, pyribenzoxim, pyributicarb, pyriclor, pyridafol, pyridate, pyriftalid, pyriminobac, pyrimisulfan, pyrithiobac-methyl, pyroxasulfone, pyroxsulam, quinclorac, quinmerac, quinoclamine, quinonamid, quizalofop, quizalofop-P-ethyl, rhodethanil, rimsulfuron, saflufenacil, S-metolachlor, sebuthylazine, secbumeton, sethoxydim, siduron, simazine, simeton, simetryn, SMA, sodium arsenite, sodium azide, sodium chlorate, sulcotrione, sulfallate, sulfentrazone, sulfometuron, sulfosate, sulfosulfuron, sulfuric acid, sulglycapin, swep, TCA, tebutam, tebuthiuron, tefuryltrione, tembotrione, tepraloxydim, terbacil, terbucarb, terbuchlor, terbumeton, terbuthylazine, terbutryn, tetrafluron, thenylchlor, thiazafluron, thiazopyr, thidiazimin, thidiazuron, thiencarbazone-methyl, thifensulfuron, thiobencarb, tiafenacil, tiocarbazil, tioclorim, topramezone, tralkoxydim, triafamone, tri-allate, triasulfuron, triaziflam, tribenuron, tricamba, triclopyr esters and amines, tridiphane, trietazine, trifloxysulfuron, trifluralin, triflusulfuron, trifop, trifopsime, trihydroxytriazine, trimeturon, tripropindan, tritac, tritosulfuron, vernolate and xylachlor.

The compositions of the present disclosure can, further, be used in conjunction with glyphosate, glufosinate, dicamba, imidazolinones, sulfonylureas, ACCase inhibitors (aryloxyphenoxyproprionates and cyclohexanediones) or 2,4-D on glyphosate-tolerant, glufosinate-tolerant, dicamba-tolerant, imidazolinone-tolerant, sulfonylurea-tolerant, ACCase inhibitor-tolerant and 2,4-D-tolerant crops. In some embodiments, the compositions described herein are used in combination with herbicides that are selective for the crop being treated and which complement the spectrum of weeds controlled by these compounds at the application rate employed. In other embodiments, the compositions of the present disclosure and other complementary herbicides are applied at the same time, either as a combination formulation or as a tank-mix.

The compositions of the present disclosure can be employed in combination with known herbicide safeners, such as benoxacor, benthiocarb, brassinolide, cloquintocet (mexyl), cyometrinil, daimuron, dichlormid, dicyclonon, dimepiperate, disulfoton, fenchlorazole-ethyl, fenclorim, flurazole, fluxofenim, furilazole, isoxadifen-ethyl, mefenpyr-diethyl, MG 191, MON 4660, naphthalic anhydride (NA), oxabetrinil, R29148 and N-phenyl-sulfonylbenzoic acid amides, to enhance their selectivity.

In practice, the compositions described herein are used in mixtures containing a herbicidally effective amount of the herbicidal components along with at least one agriculturally acceptable adjuvant or carrier. Suitable adjuvants or carriers should not be phytotoxic to valuable crops, particularly at the concentrations employed in applying the compositions for selective weed control in the presence of crops, and should not react chemically with herbicidal components or other composition ingredients. Such mixtures can be designed for application directly to weeds or an area adjacent to the weed or can be concentrates or formulations that are normally diluted with additional carriers and adjuvants before application. They can be solids, such as, for example, dusts, granules, water-dispersible granules, or wettable powders, or liquids, such as, for example, emulsifiable concentrates, solutions, emulsions or suspensions.

Suitable agricultural adjuvants and carriers that are useful in preparing the herbicidal mixtures described herein are well known to those skilled in the art. Some of these adjuvants include, but are not limited to, crop oil concentrate (mineral oil (85%)+emulsifiers (15%)); nonylphenol ethoxylate; benzylcocoalkyldimethyl quaternary ammonium salt; blend of petroleum hydrocarbon, alkyl esters, organic acid, and anionic surfactant; C₉-C₁₁ alkylpolyglycoside; phosphated alcohol ethoxylate; natural primary alcohol (C₁₂-C₁₆) ethoxylate; di-sec-butylphenol EO-PO block copolymer; polysiloxane-methyl cap; nonylphenol ethoxylate+urea ammonium nitrate; emulsified methylated seed oil; tridecyl alcohol (synthetic) ethoxylate (8EO); tallow amine ethoxylate (15 EO); PEG(400) dioleate-99.

Liquid carriers that can be employed include water, toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dimethyl alkylamides, dimethyl sulfoxide, liquid fertilizers and the like. In some embodiments, water is used for the dilution of concentrates.

Suitable solid carriers include talc, pyrophyllite clay, silica, attapulgus clay, kaolin clay, kieselguhr, chalk, diatomaceous earth, lime, calcium carbonate, bentonite clay, Fuller's earth, cottonseed hulls, wheat flour, soybean flour, pumice, wood flour, walnut shell flour, lignin, and the like.

In some embodiments, it is desirable to incorporate one or more surface-active agents into the compositions of the present disclosure. Such surface-active agents are advantageously employed in both solid and liquid compositions, especially those designed to be diluted with carrier before application. The surface-active agents can be anionic, cationic or nonionic in character and can be employed as emulsifying agents, wetting agents, suspending agents, or for other purposes. Surfactants conventionally used in the art of formulation and which may also be used in the present formulations are described, inter alia, in McCutcheon's Detergents and Emulsifiers Annual, MC Publishing Corp., Ridgewood, N.J., 1998 and in Encyclopedia of Surfactants, Vol. I-III, Chemical Publishing Co., New York, 1980-81. Typical surface-active agents include salts of alkyl sulfates, such as diethanolammonium lauryl sulfate; alkylarylsulfonate salts, such as calcium dodecylbenzene-sulfonate; alkylphenol-alkylene oxide addition products, such as nonylphenol-C₁₈ ethoxylate; alcohol-alkylene oxide addition products, such as tridecyl alcohol-C₁₆ ethoxylate; soaps, such as sodium stearate; alkylnaphthalene-sulfonate salts, such as sodium dibutyl-naphthalenesulfonate; dialkyl esters of sulfosuccinate salts, such as sodium di(2-ethylhexyl) sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; salts of mono and dialkyl phosphate esters; vegetable oils such as soybean oil, rapeseed/canola oil, olive oil, castor oil, sunflower seed oil, coconut oil, corn oil, cottonseed oil, linseed oil, palm oil, peanut oil, safflower oil, sesame oil, tung oil and the like; and esters of the above vegetable oils.

Other additives commonly used in agricultural compositions include compatibilizing agents, antifoam agents, sequestering agents, neutralizing agents and buffers, corrosion inhibitors, dyes, odorants, spreading agents, penetration aids, sticking agents, dispersing agents, thickening agents, freezing point depressants, antimicrobial agents, and the like. The compositions may also contain other compatible components, for example, other herbicides, plant growth regulants, fungicides, insecticides, and the like and can be formulated with liquid fertilizers or solid, particulate fertilizer carriers such as ammonium nitrate, urea and the like.

In some embodiments, the concentration of the active ingredients in the synergistic composition of the present disclosure is from 0.1 to 98 percent by weight, and in other embodiments, concentrations from 10 to 90 percent by weight are employed. In certain embodiments in which the compositions are designed to be employed as concentrates, the active ingredients may be present in a concentration from about 5 to about 98 weight percent, and in other embodiments from about 10 to about 90 weight percent. Such compositions may be diluted with an inert carrier, such as water, before making a post-emergence, foliar application to exposed weed and crop foliage, or may be applied as a dry or liquid formulation directly into flooded rice fields or other aquatic conditions. In some embodiments the diluted compositions are applied as a post-emergence, foliar application to weeds or the area adjacent to the weeds and contain from about 0.02 to about 20 weight percent active ingredient and in other embodiments contain from about 0.04 to about 10 weight percent active ingredient.

The present compositions can be applied to weeds or the area adjacent to the weeds by the use of conventional ground or aerial dusters, sprayers, and granule applicators, by addition to irrigation or paddy water, and by other conventional means known to those skilled in the art.

The following Examples are presented to illustrate various aspects of the compositions and methods described herein and should not be construed as limitations to the claims.

### Examples

### Evaluation of Postemergence Herbicidal Activity of Mixtures in the Field

Field trials were conducted in Brazil in pasture area cultivated with Brachiaria brizantha using standard herbicide small-plot research methodology. The plot size used was 3 meters (m)×8 m (width×length) with 4 replicates per treatment. The pasture was grown using normal cultural practices for fertilization, management, and maintenance to ensure good growth of the crop and the weeds.

All treatments in the field trials were applied using a carbon dioxide (CO₂) backpack air sprayer with flat fan nozzles)(110.03°, calibrated to apply 250 liters per hectare (L/ha) spray volume at approximately 35 pounds per square inch (PSI). Commercially available product mixtures of Aminopyralid (potassium salt)+Fluroxypyr (methyl heptyl or meptyl ester) [DOMINUM™ by Dow AgroSciences LLC] at 240 grams acid equivalent per hectare (g ae/ha) or 2 L/ha and Aminopyralid (triisopropanolammonium salt)+2,4-D (triisopropanolammonium salt) [JAGUAR™ by Dow AgroSciences LLC] at 720 g ae/ha or 2 L/ha were mixed with Flumioxazin at 25, 50, 75, 100 and 125 grams of active ingredient per hectare (g ai/ha) and water+Joint Mineral Oil at appropriate formulated product rates to achieve the desired rates based on a unit area of application (hectare) as shown. Treatments were rated at 15 to 281 days after application (DAA) as compared to the untreated control plants. Visual weed control of BOIVE was scored on a scale of 0 to 100 percent where 0 corresponds to no injury and 100 corresponds to complete kill.

Tables 1 and 2 demonstrate the herbicidal synergistic efficacy on weed control of three herbicidal active ingredients, wherein the first herbicidal active ingredient is flumioxazin, the second herbicidal active ingredient is aminopyralid and the third herbicidal active ingredient is either 2,4-D or fluroxypyr. All treatment results, both for the single product and mixtures, are an average of 3 to 4 replicates and the tank-mix interactions are significant at the P>0.05 level.

Colby's equation was used to determine the herbicidal effects expected from the mixtures (Colby, S. R. Calculation of the synergistic and antagonistic response of herbicide combinations. Weeds 1967, 15, 20-22).

The following equation was used to calculate the expected activity of mixtures containing three active ingredients, A. B, and C:

Expected=A+B+C−(AB+AC+BC)/100+(ABC)/10,000

A=observed efficacy of active ingredient A at the same concentration as used in the mixture;

B=observed efficacy of active ingredient B at the same concentration as used in the mixture;

C=observed efficacy of active ingredient C at the same concentration as used in the mixture.

However, the experiments described herein were performed such that active ingredients B and C were combined and only the efficacy of the combination was determined. As such, Colby's equation simplifies to

Expected=A+Z−(AZ/100)

A=observed efficacy of active ingredient A (flumioxazin) at the same concentration as used in the mixture;

Z=observed efficacy of a combination of active ingredient B (aminopyralid) and active ingredient C (2,4-D or fluroxypyr) at the same concentration as used in the mixture.

Some of the compounds tested, application rates employed, plant species tested, and results are given in Tables 1 and 2. All comparisons are an average of 3 to 4 replicates and are significant at the P>0.05 level.

TABLE 1
Synergistic weed control of BOIVE using Flumioxazin + Aminopyralid +
Fluroxypyr

| | | | % Visual Control | |
|---|---|---|---|---|
| | | | BOIVE | |
| Flumioxazin | Aminopyralid* | Fluroxypyr** | (281 DAA) | |
| g ai/ha | g ae/ha | g ae/ha | Obs | Exp |
| 25 | 0 | 0 | 0 | — |
| 50 | 0 | 0 | 0 | — |
| 75 | 0 | 0 | 4 | — |
| 100 | 0 | 0 | 13 | — |
| 125 | 0 | 0 | 14 | — |
| 25 | 80 | 160 | 60 | 15 |
| 50 | 80 | 160 | 63 | 15 |
| 75 | 80 | 160 | 69 | 18 |
| 100 | 80 | 160 | 70 | 26 |
| 125 | 80 | 160 | 83 | 27 |
| 0 | 80 | 160 | 15 | — |

*potassium salt
**1-methylheptyl ester

TABLE 2
Synergistic weed control of BOIVE using Flumioxazin +
Aminopyralid + 2,4-D

| | | | |
|---|---|---|---|
| | | | % Visual Control |
| | | | BOIVE |
| Flumioxazin | Aminopyralid* | 2,4-D** | (281 DAA) |

| g ai/ha | g ae/ha | g ae/ha | Obs | Exp |
|---|---|---|---|---|
| 25 | 0 | 0 | 0 | — |
| 50 | 0 | 0 | 0 | — |
| 75 | 0 | 0 | 4 | — |
| 100 | 0 | 0 | 13 | — |
| 125 | 0 | 0 | 14 | — |
| 25 | 80 | 640 | 59 | 13 |
| 50 | 80 | 640 | 64 | 13 |
| 75 | 80 | 640 | 73 | 16 |
| 100 | 80 | 640 | 71 | 24 |
| 125 | 80 | 640 | 74 | 25 |
| 0 | 80 | 640 | 13 | — |

*triisopropanolammonium salt
**triisopropanolammonium salt
BOIVE: whitehead broom (Borerria verticillata)
g ai/ha: grams active ingredient per hectare
g ae/ha: grams acid equivalent per hectare

The present invention is not limited in scope by the embodiments disclosed herein which are intended as illustrations of a few aspects of the invention and any embodiments which are functionally equivalent are within the scope of this invention. Various modifications of the compositions and methods in addition to those shown and described herein will become apparent to those skilled in the art and are intended to fall within the scope of the appended claims. Further, while only certain representative combinations of the composition components and method steps disclosed herein are specifically discussed in the embodiments above, other combinations of the composition components and method steps will become apparent to those skilled in the art and also are intended to fall within the scope of the appended claims. Thus a combination of components or method steps may be explicitly mentioned herein; however, other combinations of components and method steps are included, even though not explicitly stated. The term comprising and variations thereof as used herein is used synonymously with the term including and variations thereof and are open, non-limiting terms.

What is claimed is:

1. A herbicidal composition comprising three herbicidal active ingredients, wherein:
the first herbicidal active ingredient is flumioxazin;
the second herbicidal active ingredient is aminopyralid or a salt thereof; and
the third herbicidal active ingredient is 2,4-D or a salt thereof or fluroxypyr or an ester thereof.

2. The composition of claim 1, wherein the third herbicidal active ingredient is 2,4-D or a salt thereof.

3. The composition of claim 1, wherein the weight ratio with respect to grams of flumioxazin to grams of acid equivalent of aminopyralid or salt thereof to grams of acid equivalent of 2,4-D or salt thereof is 25-125:40-100:480-1280.

4. The composition of claim 1, wherein the weight ratio with respect to grams of flumioxazin to grams of acid equivalent of aminopyralid or salt thereof to grams of acid equivalent of 2,4-D or salt thereof is 25-125:80:640.

5. The composition of claim 1, wherein the second herbicidal active ingredient is aminopyralid triisopropanolammonium salt.

6. The composition of claim 1, wherein the third herbicidal active ingredient is 2,4-D choline salt.

7. The composition of claim 1, wherein the third herbicidal active ingredient is 2,4-D triisopropanolammonium salt.

8. The composition of claim 1, wherein the third herbicidal active ingredient is fluroxypyr or an ester thereof.

9. The composition of claim 8, wherein the weight ratio with respect to grams of flumioxazin to grams of acid equivalent of aminopyralid or salt thereof to grams of acid equivalent of fluroxypyr or ester thereof is 25-125:40-100:80-200.

10. The composition of claim 8, wherein the weight ratio with respect to grams of flumioxazin to grams of acid equivalent of aminopyralid or salt thereof to grams of acid equivalent of fluroxypyr or ester thereof is 25-125:80:160.

11. The composition of claim 8, wherein the second herbicidal active ingredient is aminopyralid potassium salt.

12. The composition of claim 8, wherein the third herbicidal active ingredient is fluroxypyr 1-methylheptyl ester.

13. The composition of claim 1, further comprising a herbicidally acceptable adjuvant or carrier.

14. A method for controlling undesirable vegetation comprising post-emergently contacting the undesirable vegetation or area adjacent to the vegetation or pre-emergently applying to soil a herbicidally effective amount of three herbicidal active ingredients, wherein:
the first herbicidal active ingredient is flumioxazin;
the second herbicidal active ingredient is aminopyralid or a salt thereof; and
the third herbicidal active ingredient is 2,4-D or a salt thereof or fluroxypyr or an ester thereof.

15. The method of claim 14, wherein the third herbicidal active ingredient is 2,4-D or a salt thereof.

16. The method of claim 14, wherein the weight ratio with respect to grams of flumioxazin to grams of acid equivalent of aminopyralid or salt thereof to grams of acid equivalent of 2,4-D or salt thereof is 25-125:40-100:480-1280.

17. The method of claim 14, wherein the weight ratio with respect to grams of flumioxazin to grams of acid equivalent of aminopyralid or salt thereof to grams of acid equivalent of 2,4-D or salt thereof is 25-125:80:640.

18. The method of claim 14, wherein the second herbicidal active ingredient is aminopyralid triisopropanolammonium salt.

19. The method of claim 14, wherein the third herbicidal active ingredient is 2,4-D choline salt.

20. The method of claim 14, wherein the third herbicidal active ingredient is 2,4-D triisopropanolammonium salt.

21. The method of claim 14, wherein the third herbicidal active ingredient is fluroxypyr or an ester thereof.

22. The method of claim 21, wherein the weight ratio with respect to grams of flumioxazin to grams of acid equivalent of aminopyralid or salt thereof to grams of acid equivalent of fluroxypyr or ester thereof is 25-125:40-100:80-400.

23. The method of claim 21, wherein the weight ratio with respect to grams of flumioxazin to grams of acid equivalent of aminopyralid or salt thereof to grams of acid equivalent of fluroxypyr or ester thereof is 25-125:80:160.

24. The method of claim 21, wherein the second herbicidal active ingredient is aminopyralid potassium salt.

25. The method of claim 21, wherein the third herbicidal active ingredient is fluroxypyr 1-methylheptyl ester.

26. The method of claim 14, further comprising a herbicidally acceptable adjuvant or carrier.

27. The method of claim 14, wherein the method is performed post-emergently in a pasture.

28. The method of claim 14, wherein the undesirable vegetation is Borreria or Spermacoce.

29. The method of claim 14, wherein the undesirable vegetation is Borreria verticillata.
